(19) United States
(12) Patent Application Publication
(10) Pub. No.: US 2005/0162442 A1
(43) Pub. Date: Jul. 28, 2005

(54) Target object appearing position display apparatus

(75) Inventors: Takayuki Baba, Kawasaki (JP); Daiki Masumoto, Kawasaki (JP); Yusuke Uehara, Kawasaki (JP); Shuichi Shiitani, Kawasaki (JP); Susumu Endo, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/077,195

(22) Filed: Mar. 11, 2005

Related U.S. Application Data
(63) Continuation of application No. PCT/JP03/00735, filed on Jan. 27, 2003.

(51) Int. Cl. G09G 5/00; G09G 5/02

(52) U.S. Cl. 345/612; 345/613; 345/696

(57) ABSTRACT

A target object appearing position display apparatus is constructed to include an object detecting part for detecting one or a plurality of specified target objects with respect to each frame of a movie, a position data holding part for holding position data of each target object that is detected, an appearing frequency computing part for computing an appearing frequency of each target object for each position, and an intensity display part for displaying an appearing frequency of each target object by an intensity value of a corresponding pixel.

### BACKGROUND OF THE INVENTION

This application is a continuation application filed under 35 U.S.C. 111(a) claiming the benefit under 35 U.S.C. 120 and 365(c) of a PCT International Application No. PCT/JP2003/000735 filed Jan. 27, 2003, in the Japanese Patent Office, the disclosure of which is hereby incorporated by reference.

1. Field of the Invention

The present invention generally relates to target object appearing position display apparatuses, and more particularly to a target object appearing position display apparatus which displays an appearing position of a target object within a movie in a form suited for classifying and analyzing features of the movie.

2. Description of the Related Art

Recently, there are increased demands by industries and the like typified by television stations to classify and analyze various movie files stored thereby, and increased demands by individuals to classify and analyze various movie files that are obtained by taking images by a video recording.

The target object appearing position display apparatus according to the present invention displays the features of each movie in an easily understandable manner. Hence, the target object appearing position display apparatus of the present invention is suited for use when searching a movie file similar to a particular movie file, classifying the genre of each movie file, analyzing a relationship of the commercials and television programs with respect to the rating, and analyzing a common style of moves directed by a certain movie director, and the like.

As methods of detecting a particular object, various methods have been proposed to detect the face of a person, a horse, a car or the like. One example of such a method of detecting a particular object is proposed in Henry Schneiderman, “A statistical approach to 3D object detection applied to faces and cars”, CMU-RI-TR-00-06, 2000. In the following description, a description will be given of the method of detecting the face of the person, which is often used, as an example of the method of detecting the particular object.

Various methods have been proposed to detect the appearing position of the face of the person from a still image or a movie. One example of such a detection method is proposed in Ming-Hsuan Yang and Narendra Ahuja, “Face detection and gesture recognition for human-computer interaction”, Kluwer Academic Publishers, ISBN: 0-7923-7409-6, 2001. Most of such detection methods display a detection result by adding a rectangular or circuit mark 2 at the position of a detected face 1, as shown in FIG. 1. FIG. 1 is a diagram for explaining an example of the conventional detection method. For this reason, when detecting the face from a still image, the user can easily understand the information indicating the position of the detected face 1 within the image, by looking at the mark 2 in the detected result.

On the other hand, when detecting the face from a movie, the face is often detected in units of still images called frames which are the basic elements forming the movie. For example, such a detection method is proposed in Sakurai et al., “A Fast Eye Pairs Detection for Face Detection”, 8th Image Sensing Symposium Lecture Articles, pp. 557-562, 2002. Hence, when detecting the face from the movie, the detected result is also displayed by adding the rectangular or circular mark at the position of the detected face in each frame corresponding to the still image, similarly as in the case where the face is detected from the still image.

In the case of the method which displays the detected result by adding the mark at the position of the detected face that is detected in units of frames, the detected result amounts to a considerably large number of frames since 30 frames generally exist per second and there are approximately 1800 frames even in the case of a movie amounting to only approximately one minute. Accordingly, there was a problem in that the operation of visually confirming the position where the face is detected with respect to each frame of the detected result is an extremely troublesome and time-consuming operation for the user. In addition, there was a problem in that it is difficult to comprehensively grasp information related to the movie as a whole, such as information indicating the position where the face was most frequently detected in the movie as a whole.

### SUMMARY OF THE INVENTION

Accordingly, it is a general object of the present invention to provide a novel and useful target object appearing position display apparatus in which the problems described above are suppressed.

Another and more specific object of the present invention is to provide a target object appearing position display apparatus which enables an appearing position of a target object within a movie to be easily grasped.

Still another object of the present invention is to provide a target object appearing position display apparatus comprising an object detecting part configured to detect one or a plurality of specified target objects, with respect to each frame of a movie; a position data holding part configured to hold position data of each target object that is detected; an appearing frequency computing part configured to compute an appearing frequency of each target object for each position; and an intensity display part configured to display an appearing frequency of each target object by an intensity value of a corresponding pixel. According to the target object appearing position display apparatus of the present invention, it is possible to easily grasp the appearing position of the target object within the movie.

Other objects and further features of the present invention will be apparent from the following detailed description when read in conjunction with the accompanying drawings.

### BRIEF DESCRIPTION OF THE DRAWINGS

FIG. 1 is a diagram for explaining an example of a conventional detection method;

FIG. 2 is a system block diagram showing an embodiment of a target object appearing position display apparatus according to the present invention;

FIG. 3 is a flow chart for explaining an embodiment of an operation of an object detecting part;

FIG. 4 is a flow chart for explaining an embodiment of an operation of a position data storing part;

FIG. 5 is a flow chart for explaining another embodiment of the operation of the position data holding part;

FIG. 6 is a flow chart for explaining still another embodiment of the operation of the position data holding part;

FIG. 7 is a diagram for explaining a computation process of an appearing frequency computing part with respect to two frames made up of four pixels;

FIG. 8 is a flow chart for explaining an important part of an embodiment of an operation of the appearing frequency computing part;

FIG. 9 is a flow chart for explaining an embodiment of an operation of an intensity display part;

FIG. 10 is a flow chart for explaining an embodiment of an operation of an image arranging part;

FIG. 11 is a diagram for explaining the operation of the image arranging part;

FIG. 12 is a diagram for explaining a classification and arrangement of a movie of an educational program;

FIG. 13 is a diagram for explaining the classification and arrangement of a movie of a news program; and

FIG. 14 is a diagram for explaining the classification and arrangement of a movie of a drama program.

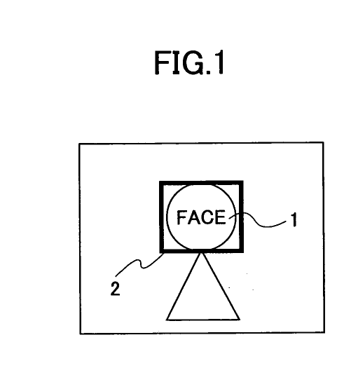

### DESCRIPTION OF THE PREFERRED EMBODIMENTS

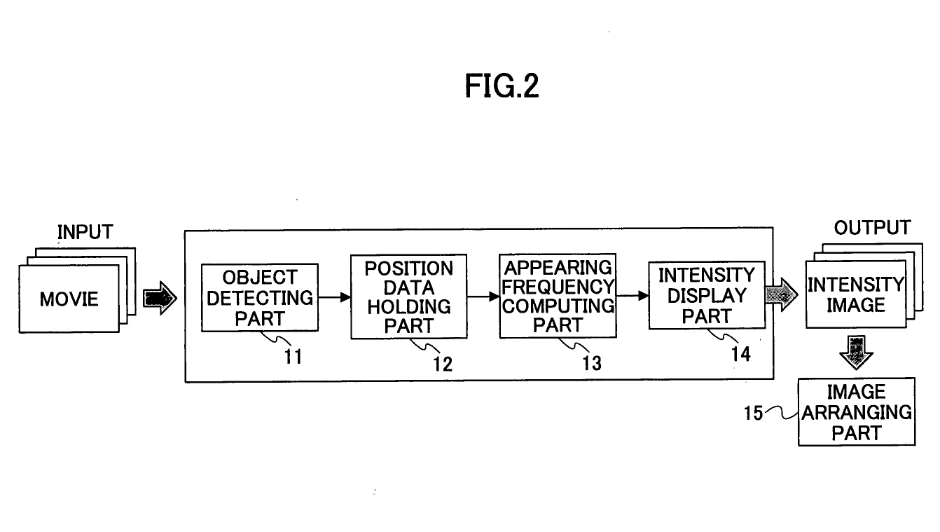

FIG. 2 is a system block diagram showing an embodiment of a target object appearing position display apparatus according to the present invention. The target object appearing position display apparatus includes an object detecting part 11 for detecting a target object from each frame of a movie (or dynamic image), a position data holding part 12 for holding a position (coordinate) of the detected target object, an appearing frequency computing part 13 for computing an appearing frequency of the target object for each position, an intensity display part 14 for displaying the appearing frequency of the target object by a gray value (intensity value) of a corresponding pixel, and an image arranging part 15 for automatically classifying and arranging the displayed intensity image based on an image feature. By employing this structure for the target object appearing position display apparatus, it becomes possible to display the appearing frequency of the target object as intensity information, and enable the appearing position of the target object within the movie to be grasped in a simple manner. Unlike the conventional case, it is unnecessary for the user to perform the extremely troublesome and time-consuming operation of visually confirming the position where the target object is detected.

Each of the functions of the object detecting part 11, the position data holding part 12, the appearing frequency computing part 13, the intensity display part 14 and the image arranging part 15 may be realized by hardware or software. In the following description, it is assumed for the sake of convenience that each of the functions of the object detecting part 11, the position data holding part 12, the appearing frequency computing part 13, the intensity display part 14 and the image arranging part 15 is realized by software, that is, by a processor such as a CPU of a known information processing apparatus such as a general purpose computer. The known information processing apparatus need only include at least a CPU and a memory.

The target object may be the face of a person, horse, car or the like. But for the sake of convenience, the following description will be given by referring to the case where the target object is the face of a person.

The object detecting part 11 receives each frame of the movie as an input, and detects and outputs the position of the target object if the target object, that is, the face of the person, appears within the frame. The movie that is input to the object detecting part 11 may be picked up by a known imaging means such as a video camera and input in real-time or, may be stored in a known storage means such as a disk and a memory and input by being read out from the storage means. The target object may be specified by the user by a known method using an input device such as a keyboard and a mouse of the known information processing apparatus, for example. Various methods have been proposed to detect the face as the target object, and one example of the method detects the face in the following manner.

First, in order to determine face candidates within the image, color information is used and a color satisfying a certain threshold value is extracted as the skin color. Then, with respect to each extracted pixel having the skin color, a distance is computed between a feature value that is obtained by subjecting a luminance value to a Gabor transform and a feature value that is obtained by subjecting a luminance value of an eye portion of a face image registered in advance within a dictionary, and the pixel is extracted as the eye if the distance is less than or equal to a preset threshold value. The face candidate including the extracted eye is detected as the face. For example, such a detecting method is proposed in L. Wiskott et al., “Face recognition by elastic bunch graph matching”, PAMI vol. 19, no. 7, pp. 775-779, 1997. This proposed detecting method uses the feature values that have been subjected to the Gabor transform, but there is a method of performing a pattern matching simply using the luminance values as the feature values.

Of course, the face detection method itself and the target object method detection itself are not limited to the detection method described above.

The object detecting part 11 may not detect the target object with respect to all frames of the movie, and detect the target object only with respect to the frames satisfying a prespecified condition that is specified in advance. For example, the condition may be specified so that the target object is detected only with respect to the frames extracted at predetermined intervals or, only with respect to the frames having a large change in the image feature value. By detecting the target object only with respect to the frames satisfying the prespecified condition, it is possible to reduce the time required to detect the target object.

Furthermore, the object detecting part 11 may detect a single target object or detect a plurality of target objects such as the face of the person and a car. When detecting a plurality of target objects, it is possible to employ a method of detecting the plurality of target objects in one process or, a method of detecting the plurality of target objects by carrying out a process of detecting the single object a plurality of times.

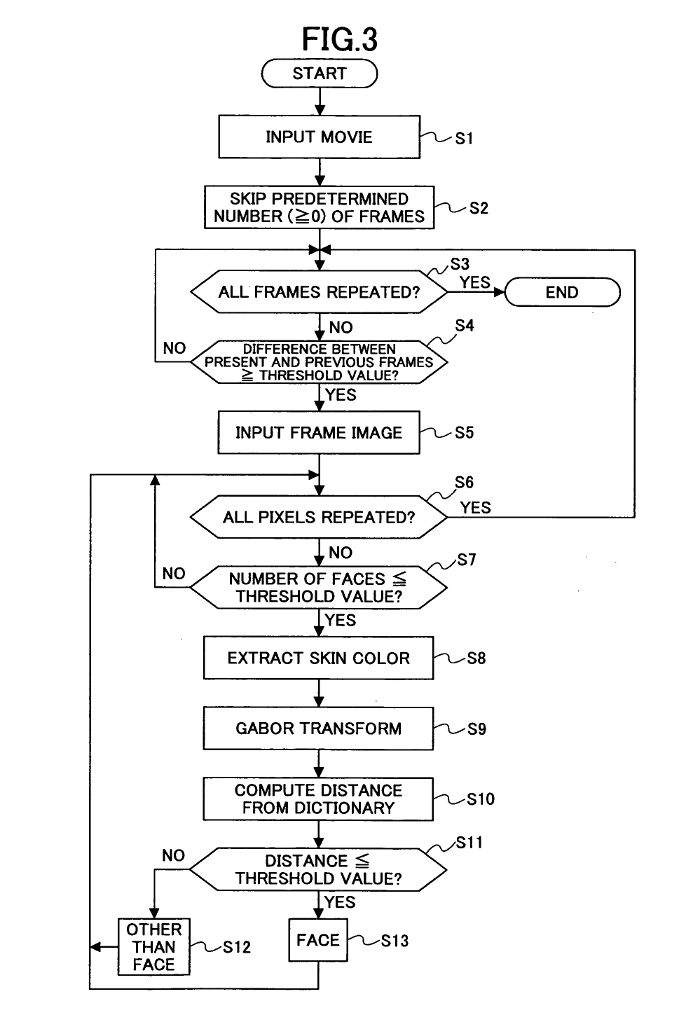

FIG. 3 is a flow chart for explaining an embodiment of the operation of the object detecting part 11. In FIG. 3, a step S1 inputs the movie, and a step S2 skips a predetermined number of frame images. A step S3 decides whether or not all frames have been repeated (all frames have been processed), and if the decision result is NO, a step S4 decides whether or not a difference between the present frame and the previous frame is greater than or equal to a threshold value. The process returns to the step S3 if the decision result in the step S4 is NO. On he other hand, if the decision result in the step S4 is YES, a step S5 inputs the frame image.

A step S6 decides whether or not all pixels have been repeated, and if the decision result is YES, the process returns to the step S3. If the decision result in the step S6 is NO, a step S7 decides whether or not the number of faces that are the target objects specified by the user is less than or equal to a threshold value. The process returns to the step S6 if the decision result in the step S7 is NO. On the other hand, if the decision result in the step S7 is YES, a step S8 extracts the skin color from the frame image, and a step S9 subjects the luminance value to a Gabor transform with respect to each pixel having the extracted skin color. A step S10 computes a distance (or error) between the feature value that is obtained by this Gabor transform and a feature value that is obtained by subjecting the luminance value of the eye portion of the face image that is registered in advance in a dictionary to a Gabor transform. A step S11 decides whether or not the computed distance is less than or equal to a threshold value. If the decision result in the step S11 is NO, a step S12 judges that other than the face is detected, and the process returns to the step S6. On the other hand, if the decision result in the step S11 is YES, a step S13 judges that the face is detected, and the process returns to the step S6. The process shown in FIG. 3 ends if the decision result in the step S3 becomes YES.

The position data holding part 12 holds the position coordinate of the target object (face) detected by the object detecting part 11. In this case, since a plurality of pixels corresponding to one detected target object exit in most cases, it is possible for example to hold all coordinates of the pixels corresponding to the one detected target object or, hold the coordinate of a prespecified location (for example, center of gravity) of a region of the detected target object or, hold the coordinate of a prespecified part (for example, eye, nose, mouth and the like when the face is the target object) of the region of the detected target object. Accordingly, in a case where it is desirable to eliminate the effects of an extremely small object, for example, it is possible to prespecify a condition that the coordinate will not be held with respect to an object that is smaller than a predetermined size. In addition, by specifying a particular portion within the object, it is possible in general to more accurately grasp the position of the target object spanning a plurality of pixels.

It is possible to hold the position data for each prespecified condition in order to independently count the appearing frequency of the detected target objects for each prespecified condition by separating the detected target objects according to the each prespecified condition. For example, it is possible to specify each direction of the target object as the condition, and hold the position data for each direction. Various other conditions may be specified, such as the kind of the target object and the size of the target object.

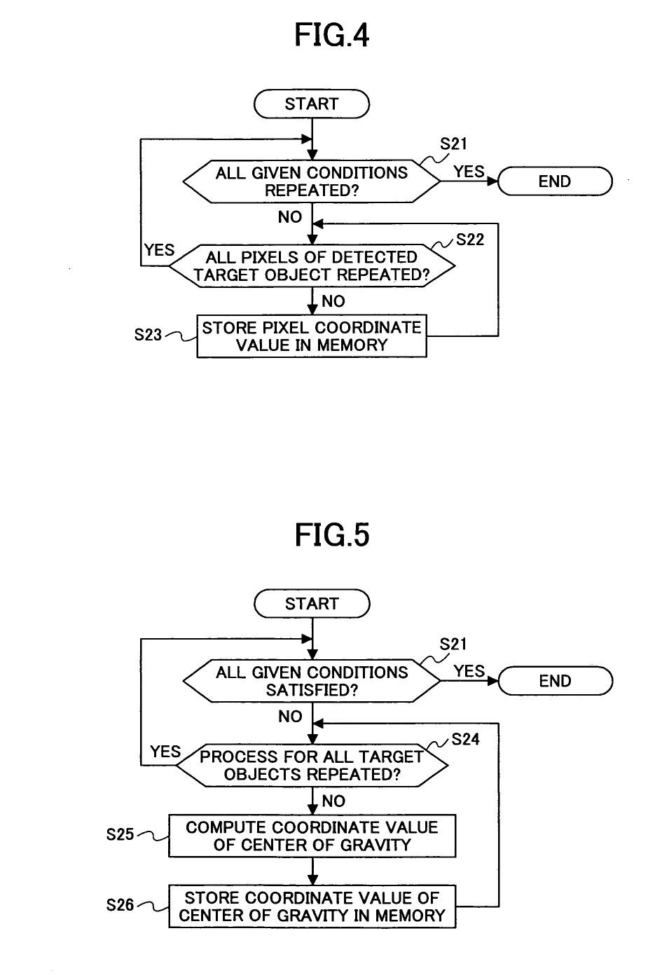

FIG. 4 is a flow chart for explaining an embodiment of the operation of the position data holding part 12. In FIG. 4, a step S21 decides whether or not all given conditions have been repeated (process has been carried out under all given conditions). If the decision result in the step S21 is NO, a step S22 decides whether or not all pixels of the detected target object have been repeated, and if the decision result is YES, the process returns to the step S21. On the other hand, if the decision result in the step S22 is NO, a step S23 stores the pixel coordinate values in the memory, and the process returns to the step S22. The process shown in FIG. 4 ends if the decision result in the step S21 becomes YES.

FIG. 5 is a flow chart for explaining another embodiment of the operation of the position data holding part 12. In FIG. 5, those steps which are the same as those corresponding steps in FIG. 4 are designated by the same reference numerals, and a description thereof will be omitted. In FIG. 5, a step S24 decides whether or not the process has been repeated with respect to all target objects, and if the decision result is YES, the process returns to the step S21. If the decision result in the step S24 is NO, a step S25 computes the coordinate values of the center of gravity of the detected target object. A step S26 stores the coordinate values of the center of gravity in the memory, and the process returns to the step S24. The process shown in FIG. 5 ends if the decision result in the step S21 becomes YES.

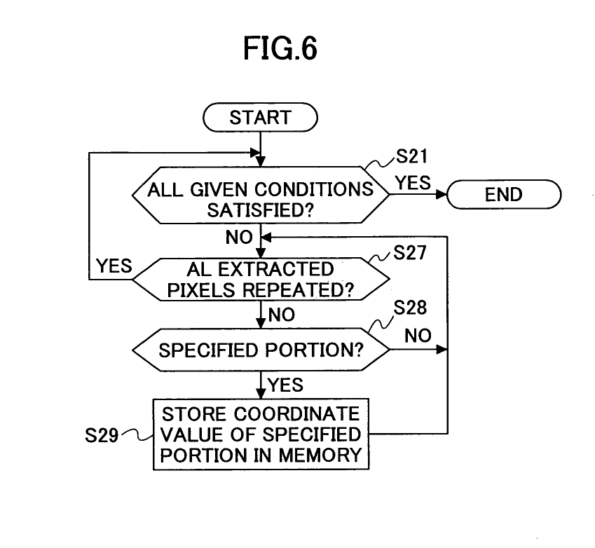

FIG. 6 is a flow chart for explaining still another embodiment of the operation of the position data holding part 12. In FIG. 6, those steps which are the same as those corresponding steps in FIG. 4 are designated by the same reference numerals, and a description thereof will be omitted. In FIG. 6, a step S27 decides whether or not all extracted pixels have been repeated, and if the decision result is YES, the process returns to the step S21. If the decision result in the step S27 is NO, a step S28 decides whether or not the it is the specified portion of the detected target object, and if the decision result is NO, the process returns to the step S27. If the decision result in the step S28 is YES, a step S29 stores the coordinate values of the specified portion in the memory, and the process returns to the step S27. The process shown in FIG. 6 ends if the decision result in the step S21 becomes YES.

The appearing frequency computing part 13 computes the appearing frequency of the target object at each coordinate, based on the position data held in the position data holding part 12. The appearing frequency of the target object may be computed by a computing process including the following steps ST1 through ST5.

Step ST1: Initialize an appearing frequency C of the target object at each coordinate to 0.

Step ST2: Count (increment) the appearance number C of the target object at each coordinate.

Step ST3: Compute a sum total S of the appearance numbers C of the target object.

Step ST4: Compute an appearance rate R=C/S by dividing the appearance number C of the target object at each coordinate by S.

Step ST5: Compute an intensity value I=R×255 by multiplying a maximum luminance value (255 in the case of 8 bits) to the appearance rate R.

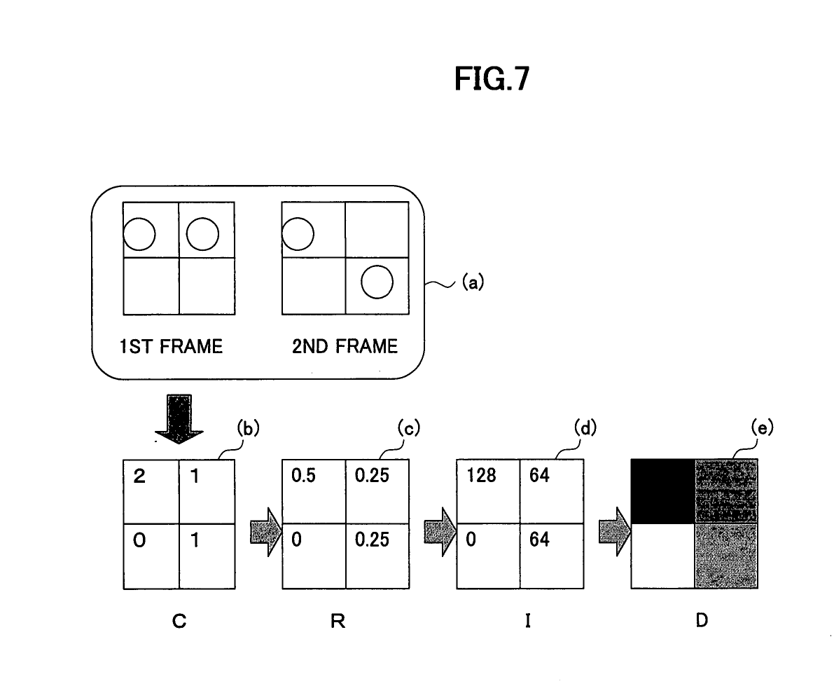

FIG. 7 is a diagram for explaining a computation process of the appearing frequency computing part 13 with respect to two frames made up of four pixels. In FIG. 7, a symbol “O” indicates a pixel of the detected target object. In addition, (a) indicates two frames, (b) indicates the appearance number C of the target object with respect to two frames, (c) shows the appearance rate R, (d) shows the intensity value I, and (e) shows an intensity display D that is displayed when the intensity value I is displayed by the intensity display part 14 which will be described later.

It is possible to independently count the appearing frequency of the detected target objects for each prespecified condition by separating the detected target objects according to the each prespecified condition. For example, it is possible to specify each direction of the target object as the condition, and count the appearing frequency for each direction. Various other conditions may be specified, such as the kind of the target object, the size of the target object and the appearance number of the target object.

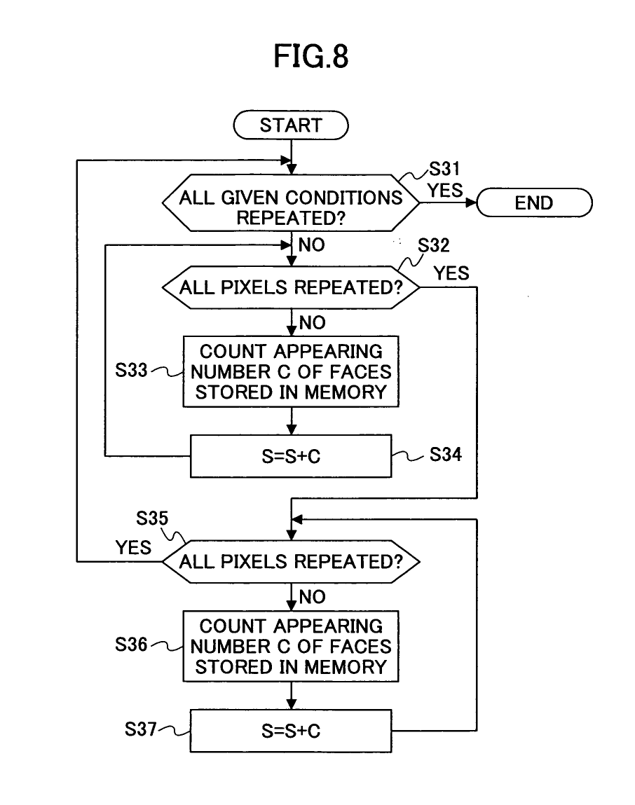

FIG. 8 is a flow chart for explaining an important part of an embodiment of the operation of the appearing frequency computing part 13. In FIG. 8, a step S31 decides whether or not all given conditions have been repeated (process has been carried out under all given conditions) with respect to the held position data of the target object. If the decision result in the step S31 is NO, a step S32 decides whether or not all pixels of the target object have been repeated, and if the decision result is YES, the process advances to a step S35 which will be described later. On the other hand, if the decision result in the step S32 is NO, a step S33 counts the appearance number C of the target object stored in the memory. In addition, a step S34 obtains the sum total S of the appearance numbers C of the target object from S=S+C, and the process returns to the step S32.

The step S35 decides whether or not all pixels of the target object have been repeated, and if the decision result is YES, the process returns to the step S31. If the decision result in the step S35 is NO, a step S36 counts the appearance numbers C of the target object stored in the memory. In addition, a step S37 obtains the sum total S of the appearance numbers C of the target object from S=S+C, and the process returns to the step S35. The process shown in FIG. 8 ends when the decision result in the step S31 becomes YES. The appearance rate R and the intensity value I may be obtained similarly to the steps ST4 and ST5 described above.

The intensity display part 14 displays the intensity value of each coordinate computed by the appearing frequency computing part 13 on a display part of the general purpose computer described above, as luminance information (intensity value) of the corresponding pixel of the intensity image that is output. In the case where the appearing frequency computing part 13 carries out the steps ST1 through ST5 described above, the intensity display part 14 carries out an intensity display process including the following step ST6.

Step ST6: Set the intensity value I of the target object at each coordinate as the luminance information [0 to 255] of the corresponding pixel of the intensity image.

It is possible to independently make the intensity display of the appearing frequency of the detected target objects for each prespecified condition by separating the detected target objects according to the each prespecified condition. More particularly, when considering each direction of the target object, for example, it is possible to independently make the intensity display with respect to the target objects for each prespecified condition, by preparing three kinds of intensity displays, namely, an intensity display representing the appearing frequency in a rightward direction, an intensity display representing the appearing frequency in a frontward direction, and an intensity display representing the appearing frequency in a leftward direction.

It is possible to independently make the intensity display of the appearing frequency of the detected target objects in a different color for each prespecified condition, by separating the detected target objects according to the each prespecified condition and assigning a different color for each prespecified condition. More particularly, when considering each direction of the target object, for example, it is possible to independently make the intensity display with respect to the target objects in a different color for each prespecified condition, by displaying the appearing frequency in the rightward direction by a red intensity, displaying the appearing frequency in the frontward direction by a blue intensity, and displaying the appearing frequency in the leftward direction by a green intensity.

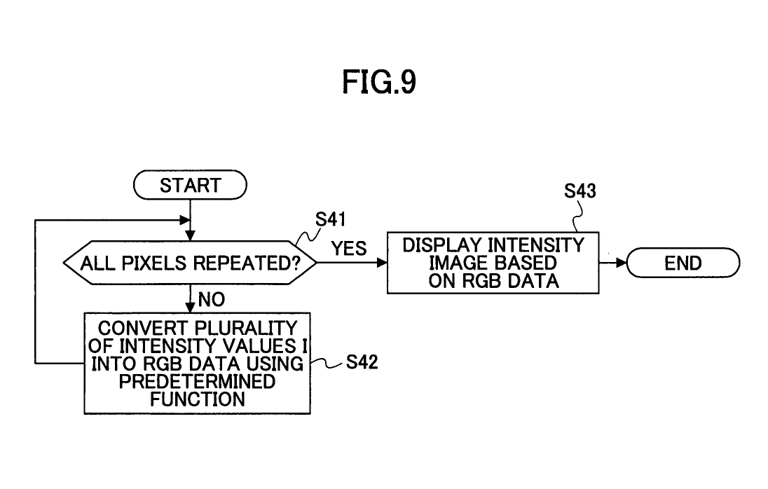

FIG. 9 is a flow chart for explaining an embodiment of the operation of the intensity display part 14. In FIG. 9, a step S41 decides whether or not all pixels of the target object for which the appearing frequency is computed has been repeated (all pixels of the target object have been processed). If the decision result in the step S41 is NO, a step S42 converts a plurality of intensity values I into RGB data according to a predetermined function, and the process returns to the step S41. On the other hand, if the decision result in the step S41 is YES, a step S43 displays an intensity image on the display part based on the RGB data, and the process ends.

The image arranging part 15 automatically classifies and arranges the displayed intensity images based on an arbitrary image feature value. A method of automatically classifying and arranging not only the intensity image but also the image in general is proposed in Susumu Endo et al., “MIRACLES: Multimedia Information Retrieval, Classification, and Exploration System”, In Proc. of IEEE International Conference on Multimedia and Expo (ICME2002), 2002, for example. According to this classifying and arranging method, a specified image feature value (color, texture, shape, etc.) is automatically extracted from each image, a distance between the extracted image feature values of an arbitrarily selected image and each image is computed, and images similar to the selected image (having a small distance) are displayed in the order of similarity. Of course, the image arranging part 15 may classify and arrange the intensity image by methods other than the classifying and arranging method described above. In addition, since the intensity image that is displayed by the intensity display part 14 is a partial set of general images, it is possible to input the intensity image to the image arranging part 15 which employs a known classifying and arranging method.

The position data holding part 12 and the appearing frequency computing part 13 can independently count the appearing frequency of the detected target objects for each prespecified condition by separating the detected target objects according to the each prespecified condition, and the intensity display part 14 can use a different color for each prespecified condition when displaying the appearing frequency as the intensity information. Accordingly, it is possible to grasp the appearing frequency for each direction of the target object, for example. It is possible to grasp the appearing frequency in more detail by specifying the direction or orientation of the target object by the condition, and as the condition, for example, the appearing frequency of the target object facing the rightward direction may be set higher than the appearing frequency of the target object facing the frontward direction.

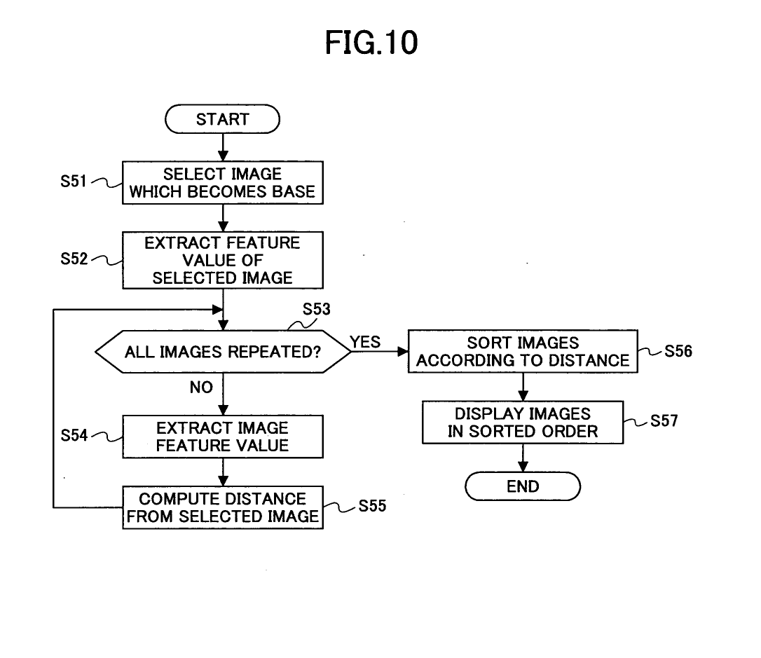

FIG. 10 is a flow chart for explaining an embodiment of the operation of the image arranging part 15. In FIG. 10, a step S51 selects an image which becomes a base, from the intensity images displayed by the intensity display part 14. A step S52 extracts a predetermined image feature value of the selected image by a known method. A step S53 decides whether or not all images have been repeated (all images have been processed). If the decision result in the step S53 is NO, a step S54 extracts by a known method a predetermined image feature value of the image which has not been processed. In addition, a step S55 computes a distance between the image feature value of the selected image extracted in the step S52 and the image feature value of the image extracted in the step S54, and the process returns to the step S53.

On the other hand, if the decision result in the step S53 is YES, a step S56 sorts all images according to the order (size) of the distance. In addition, a step S57 displays all images on the display part in the sorted order, and the process ends. In this embodiment, the image arranging part 15 carries out the classification and arrangement based on the intensity images displayed on the display part by the intensity display part 14. However, it is of course possible to directly classify and arrange the intensity images output from the intensity display part 14 and to display the sorted result on the display part.

The image arranging part 15 automatically classifies and arranges the intensity information obtained from the intensity display part 14 based on the image feature value, and displays the sorted result. For this reason, by classifying and arranging the intensity images similar to a certain intensity image A, for example, it is possible efficiently search the movies having a similar appearing frequency of the target object as the movie corresponding to the certain intensity image A. Moreover, it is also possible to grasp the number of intensity images having similarities to a certain extent, and to grasp the similarities of a group of intensity images that are arranged locally.

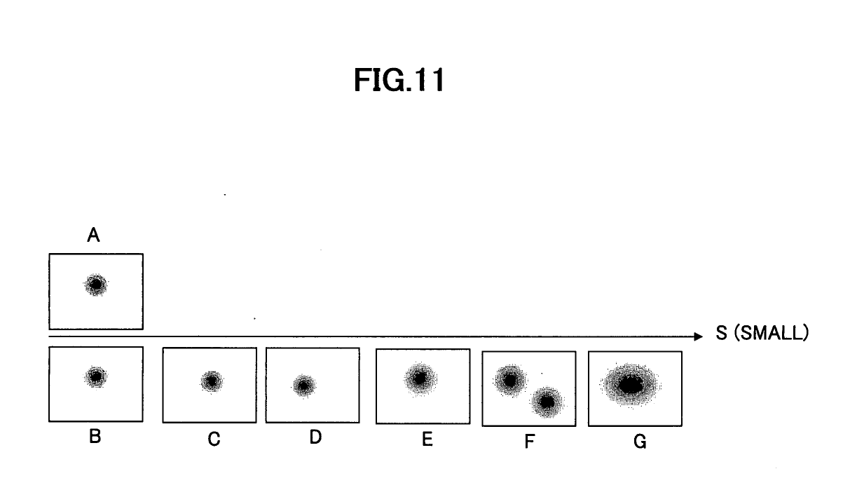

FIG. 11 is a diagram for explaining the operation of the image arranging part 15. More particularly, FIG. 11 shows a sorted result that is obtained when intensity images B through G similar to the certain intensity image A are classified and arranged by the image arranging part 15. In FIG. 11, an arrow indicates a similarity S, and the similarity S is smaller towards the right.

The intensity display part 14 displays the appearing frequency of the target object by the intensity value of the pixel at each position, based on the information computed in the appearing frequency computing part 13. In other words, since the intensity value representing the appearing frequency of the target object is automatically computed based on the detection result of the target object with respect to each frame of the movie, it is possible to represent the appearing position of the target object appearing within the movie by an intensity distribution. For this reason, by viewing the intensity distribution corresponding to each movie, the user can easily and visually grasp the appearing position of the target object within the movie. Hence, the image arranging part 15 may be omitted in a case where the user carries out the classification and arrangement of the intensity information by viewing the intensity distribution corresponding to each movie.

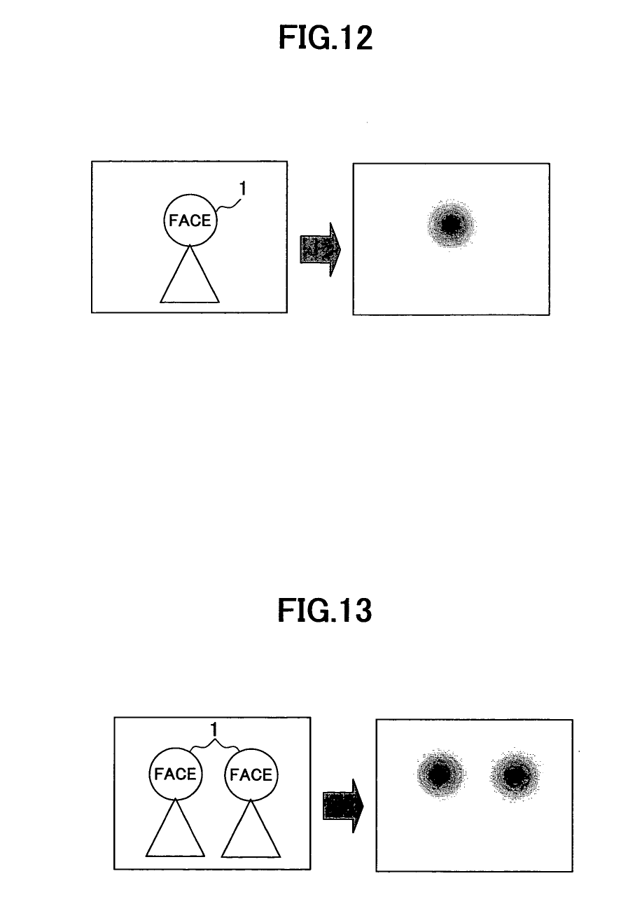

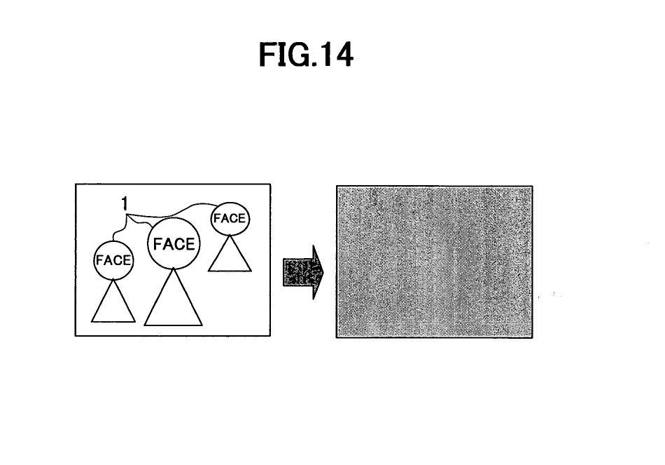

The following are examples of the cases where it is necessary to grasp the appearing position of the face of the person, as the target object, with respect to the movie. FIG. 12 is a diagram for explaining the classification and arrangement of the movie of an educational program. FIG. 13 is a diagram for explaining the classification and arrangement of the movie of a news program. FIG. 14 is a diagram for explaining the classification and arrangement of the movie of a drama program. In FIGS. 12 through 14, the face 1 is the target object, the left side shows the movie, and the right side shows the corresponding intensity image.

C1) Genre Classification of Dynamic Image: With respect to a large number of movies, the present invention can gather movies having similar intensity information and classify such movies in the same genre. For example, in the case of the group of movies of the educational program having many scenes in which one lecturer is lecturing at the center of the screen, the intensity display that is made has a high intensity in the vicinity of the center of the screen for each movie, as shown in FIG. 12. In addition, in the case of the news program that is presented by two newscasters and broadcast everyday, the intensity display that is made has a high intensity at two positions in the vicinity of the right and left of the screen for the movie of each day of the week, as shown in FIG. 13. Moreover, in the case of the drama program in which the face of the person appears at various positions in the screen, the intensity information becomes approximately uniform, as shown in FIG. 14. Therefore, by classifying the movies having similar intensity information of the present invention in the same genre, it is possible to classify the movies in genres according to an index which indicates that the appearing tendencies of the face of the person are similar.

C2) Analysis of Commercials and Programs: As a method of analyzing the commercials and the programs, it is possible to utilize the present invention for finding the features and knowledge common to the movies, with respect to the commercials and the programs having a high rating. For example, the knowledge common to the movies may be that “the appearing frequency of the face is high at the center portion of the screen for the commercials having a high rating”.

C3) Analyzing Style: The intensity display of the present invention may be utilized as one feature value that is used to extract the knowledge common to a group of films (movies) directed by a certain movie director. For example, the knowledge common to the group of movies may be that “there is a strong tendency for the face of the person to appear uniformly in the entire screen for the movies shot by a director Y”.

Therefore, because the present invention can represent the appearing frequency of a particular target object appearing within the movie by an intensity distribution (intensity image), it is possible to easily grasp the appearing position of the target object appearing within the movie. In addition, since the intensity image reflecting the appearing tendency of the target object is obtained by employing the present invention, it is possible to automatically classify and arrange the intensity image by inputting the obtained intensity image to the image arranging part. Hence, it is possible, for example, to grasp the similarity and the like related to the appearing tendency of the target object with respect to a plurality of movies.

Thus, according to the present invention, it is possible to classify the genre of the movies, analyze the commercials and the programs, and analyze the style by using, as a new point of view, the appearing position of the target object (for example, the face of the person) within the movie.

Further, the present invention is not limited to these embodiments, but various variations and modifications may be made without departing from the scope of the present invention.

1. A target object appearing position display apparatus comprising:
an object detecting part configured to detect one or a plurality of specified target objects, with respect to each frame of a movie;
a position data holding part configured to hold position data of each target object that is detected;
an appearing frequency computing part configured to compute an appearing frequency of each target object for each position; and
an intensity display part configured to display an appearing frequency of each target object by an intensity value of a corresponding pixel.

2. The target object appearing position display apparatus as claimed in claim 1, wherein the object detecting part detects each target object only with respect to each frame satisfying a prespecified condition.

3. The target object appearing position display apparatus as claimed in claim 1, wherein the position data holding part only holds the position data of each target object satisfying a prespecified condition.

4. The target object appearing frequency display apparatus as claimed in claim 1, wherein the position data holding part holds the position data of only a prespecified portion of each target object that is detected.

5. The target object appearing frequency display apparatus as claimed in claim 4, wherein the prespecified portion is a center of gravity of each target object or an eye if the target object is a face.

6. The target object appearing position display apparatus as claimed in claim 1, wherein the position data holding part and the appearing frequency computing part independently count the appearing frequency of the detected target objects for each prespecified condition by separating the detected target objects according to the each prespecified condition.

7. The target object appearing position display apparatus as claimed in claim 1, wherein the intensity display part independently makes an intensity display of the appearing frequency of the detected target objects for each prespecified condition, when representing the appearing frequency of each target object.

8. The target object appearing position display apparatus as claimed in claim 1, wherein the intensity display part independently makes an intensity display of the appearing frequency of the detected target objects in a different color for each prespecified condition, when representing the appearing frequency of each target object.

9. The target object appearing frequency display apparatus as claimed in claim 1, further comprising:
an image arranging part configured to automatically classify and arrange images of intensity values output by the intensity display part.
